(19) United States
(12) Patent Application Publication
(10) Pub. No.: US 2014/0093080 A1
(43) Pub. Date: Apr. 3, 2014

(54) METHOD AND SYSTEM TO DIFFERENTIATE AND ASSIGNING IP ADDRESSES TO WIRELESS FEMTO CELLS H(E)NB (HOME (EVOLVED) NODEB) AND LGW (LOCAL GATEWAY) BY USING IKEV2 (INTERNET KEY EXCHANGE VERSION 2 PROTOCOL) PROCEDURE

(71) Applicant: Rajavelsamy Rajadurai, Bangalore (IN)

(72) Inventor: Rajavelsamy Rajadurai, Bangalore (IN)

(73) Assignee: Samsung Electronics Co. Ltd., Suwon-si, Gyeonggi-do (KR)

(21) Appl. No.: 14/008,913

(22) PCT Filed: Mar. 30, 2012
(86) PCT No.: PCT/KR2012/002375

§ 371 Date: Sep. 30, 2013

(30) Foreign Application Priority Data
Mar. 30, 2011 (IN) 998/CHE/2011

(51) Int. Cl. H04W 12/04

(52) U.S. Cl. CPC H04W 12/04
USPC 380/270

(57) ABSTRACT

A method and a system to differentiate and assign IP addresses of wireless femto cells H(e)NB (Home (evolved) NodeB) by using IKEv2 (Internet Key Exchange Version 2 protocol) procedure when supporting multiple logical entities or service are provided. The present disclosure relates to broad area of IP networks and particularly relates to a signaling mechanism to support multiple services by providing particular IP address to particular service within an IP based entity. Different methods to differentiate the assigned IP addresses for multiple IP request for different entities (logical or physical), the GW (IKEv2 peer)/H(e)NB (IKEv2 peer) attaches an unique identification in the payload for each entity using IKEv2 procedure.

### TECHNICAL FIELD

The present invention relates to Internet Protocol (IP) network and more particularly relates to differentiating and assigning IP addresses for IKEv2 peers.

### BACKGROUND ART

With the progressive convergence of the Internet world and of the telecommunications world, most services that are offered on the Internet become available on mobile phones, and conversely voice services become available through the Internet (Voice over IP). In addition to this, fixed-mobile convergence aims at proposing single communication devices able to connect both to a cellular network and to a local network (such as a home network, when at home, or a corporate network, or a hotspot).

Small cellular base stations called femtocells can be used to mitigate the unavailability of cellular networks, as long as an alternate network access (typically a wired network) is available. Femtocell is a low-powered wireless access point that operates in licensed spectrum to connect standard mobile devices to a mobile operator's networking using residential broadband connections. Femtocells can typically be simple devices installed at end users premises and often know as Home gateway or residential gateway. Femtocells behave like a cellular network with respect to communication devices, and connect to a cellular network operator's core network through the alternate network access (such as Internet access via fiber, DSL or cable subscriptions). Femtocells can be developed for any types of cellular networks technologies, for example WCDMA, GSM, CDMA2000, TD-SCDMA, WiMAX or LTE technologies. The 3GPP refers to 3G Femtocells as Home NodeBs (HNBs), and in LTE the terminology for a Femtocell is Home enhanced NodeB (HeNB). Femtocells are in fact “home” cellular base stations. The term H(e)NB refers to both Home NodeB (HNB) and Home eNodeB (HeNB).

Within an H(e)NB architecture there are three new network elements: the H(e)NB (or Femtocell), the Security Gateway (SeGW) and the H(e)NodeB Gateway, or H(e)NB-GW. A Security Gateway provides secure termination and aggregation for users and signaling traffic to reach the mobile operator's core network. Examples of functions provided by Security Gateway are IPSec tunnel, DoS Mitigation, Dynamic Session Security and Real-time Bandwidth management to provide security for mobile operators' networks and their users.

Internet Key Exchange Version 2 (IKEv2) is a protocol used to set up a security association (SA) in the IP protocol suite. IKEv2 has been adopted by many standardized network solutions to provide the secure transport between network elements over third party's infrastructure. The IKEv2 peers can request for a IP address or multiple IP addresses and the other peer can assign one or more IP address for operation.

IKEv2 are extensively used for VPN tunnel creation and the Gateway which uses the IKEv2,? to request multiple IP address for different services/logical entities/interface. For example, cellular base-station (eNB) need multiple IP address for different interfaces like S1 interface (to core network), OAM interface (for configuration), X2 interface (between eNBs). Similarly H(e)NB need multiple IP address for? S1, S5 and OAM. However, currently there is no mechanism provided? by the IKEv2 to carry information about the IP address assigned for specified service/interface/logical entity.

Assignment of Remote (inner) IP address for H(e)NB (Home (evolved) NodeB) is done within IKEv2 procedure. Mobile Network Operator may like to assign pool of IP address for a particular service or logical entity and different pool of IP address for H(e)NB for easy, efficient management and operation purpose. In IKEv2, multiple IP addresses can be assigned to H(e)NB during IKEv2 procedure, but the H(e)NB is not aware of which IP address is for its operation and which IP address is for which particular service or logical entity. For example, if Local IP Access (LIPA) is activated for a H(e)NB, then H(e)NB may request different Remote IP addresses for the H(e)NB and for the L-GW, and SeGW (Security Gateway) may assign different remote (i.e. inner) IP address to the L-GW than the remote (i.e. inner) IP address allocated to the H(e)NB (Rel-10) (TS 33.320 v10.1.0).

### DISCLOSURE OF INVENTION

### Technical Problem

With the current IKEv2 procedure (defined in Internet Engineering Task Force (IETF)), the SeGW can send multiple IP addresses to the H(e)NB based on request. However, if two IP addresses are issued to the H(e)NB by the SeGW using IKEv2 protocol, then H(e)NB need information about the IP address assignment (which IP address to be configured for L-GW/H(e)NB) for appropriate IP address configuration and information. If this information is not provided, it will lead to mis-configuration of the IP addresses and cause network access failure.

Also for example, the assignment of the remote IP address for the Home gateway or Setup Box or residential gateway is done within IKEv2 procedure. Service provider may like to assign pool of IP address for a particular service and different pool of IP address for some other service for easy and efficient management purpose. In this case when two or more IP addresses are issued to the Home gateway or Setup Box or residential gateway, then which IP address to be configured for a particular service is not known and this lead to mis-configuration and network access failure.

Due to the aforementioned reasons it is evident that there is a need for a method to clearly indicate the assignment of IP addresses to different services. This is necessary to avoid mis-configuration and network access failure.

### Solution to Problem

Accordingly the invention provides a method for assigning Internet Protocol (IP) addresses for services in Internet Key Exchange (IKEv2) procedure in a communication network. The network comprising at least one Home Gateway and at least one network security gateway, further the method comprising sending a request in configuration payload by the Home Gateway to the security gateway for allocation of service specific IP addresses for each the service, processing of the request in configuration payload by the security gateway, and sending a response to the Home Gateway in the configuration payload indicating the IP addresses for the services by the security gateway.

Accordingly the invention provides a Home Gateway for differentiation of Internet Protocol (IP) addresses for services in Internet Key Exchange (IKEv2) procedure in a communication network. The Home Gateway is configured for sending a request in configuration payload to a security gateway for allocation of specific IP addresses for each service served by the Home Gateway, and receiving a response in the configuration payload indicating assignment of the IP addresses for the services from the security gateway.

Accordingly the invention provides a security gateway for assigning Internet Protocol (IP) addresses for services in Internet Key Exchange (IKEv2) procedure in a communication network. The gateway configured for receiving a request in configuration payload from a Home Gateway for allocation of specific IP addresses for each the service, processing of the request in configuration payload by the security gateway, and sending a response to the Home Gateway in the configuration payload indicating assignment of the IP addresses for the services.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

FIG. 1 illustrates the H(e)NB (Home (evolved) NodeB) security architecture interconnecting with the Security Gateway (SeGW) in IKEv2 procedure, according to embodiments as disclosed herein;

FIG. 2 illustrates the message flow for IKEv2 procedure with IP address assignment between the H(e)NB and the core network, according to embodiments as disclosed herein;

FIG. 3 illustrates the H(e)NB notification using Configuration Payload Attribute Type employing Internet Key Exchange Version 2 protocol (IKEv2) procedure, according to embodiments as disclosed herein;

FIG. 4 illustrates the Gateway notification using Configuration Attribute Payload Reserved bit, according to embodiments as disclosed herein;

FIG. 5 illustrates the initiator or responder using the reserved bytes in the Generic Payload Header when used for Configuration Payload to indicate the device/service requesting the IP address, according to embodiments as disclosed herein;

FIG. 6 illustrates a notification using Notified Payload along with the CFG_REQUEST and CFG_REPLY payload in the messages the identities are exchanged, according to the embodiments as disclosed herein; and

FIG. 7 illustrates the H(e)NB notification using CFG Attribute Type using Internet Key Exchange Version 2 protocol (IKEv2) procedure, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve a system and method to differentiate the IP addresses request and assignment for wireless Femto cells in mechanisms employing IKEv2 (Internet Key Exchange Version 2 protocol) procedure. The present invention relates to broad area of IP networks and particularly relates to a signaling mechanism to support multiple services by providing particular IP address to particular service within a IP based entity. The present invention more particularly relates to a signaling mechanism to support multiple services like local IP access within wireless Femto cells (H(e)NB). For multiple IP (Internet Protocol) request for different entities (logical or physical) and/or services, the Home Gateway (H(e)NB) (IKEv2 (Internet Key Exchange Version 2 protocol) peer attaches an identification in the payload for each entity and/or service, to assign appropriate network configuration values (IP address). The responder (IKEv2 peer) replies with IP address(es) and information of the IP address(es) that are assigned to different entities and/or services for appropriate IP configuration.

In one embodiment, the H(e)NB is a cellular macro base station like NodeB or eNodeB or residential gateway or setup box. The NodeB or the eNodeB request multiple IP address within IKEv2 procedure from the core network or the Operations And Management (OAM) with identification in the payload for each interfaces or logical entities or services co-located and supported within the NodeB or the eNodeB. Then the core network or the Operations And Management (OAM) network replies with IP address(es) and information of the IP address(es) that are assigned to different entities and/or services for appropriate IP configuration.

The wireless Femtocells communicates with the security gateway (SeGW) which provides secure termination and aggregation for users and signaling traffic to reach the mobile operator's core network through the IKEv2 procedure. IKEv2 (Internet Key Exchange version 2) was standardized by the Internet Engineering Task Force (IETF) to provide a robust means to address the authentication requirements of H(e)NB and the SeGW and security association establishment. IKEv2 is a flexible protocol that supports a wide and varied set of use cases with support for many actual authentication methods. The IKEv2 protocol supports the mutual strong authentication of communicating peers over PKI certificates, shared keys or with the use of various methods of the extended authentication protocol (EAP). The use of EAP within IKEv2 provides the means for an even wider set of authentication protocols, such as the EAP-AKA and/or EAP-SIM that leverage the existing authentication back-ends and AAA servers in the telecommunications use cases. In an embodiment, the methods discussed herein are applicable for all services employing IKEv2 procedure. The embodiments discussed herein may be applicable to 3GPP systems, 3G (UMTS), WiMAX network, Internet Service Provider, application service provider, Virtual Private Network and LTE (Long Term Evolution) technologies.

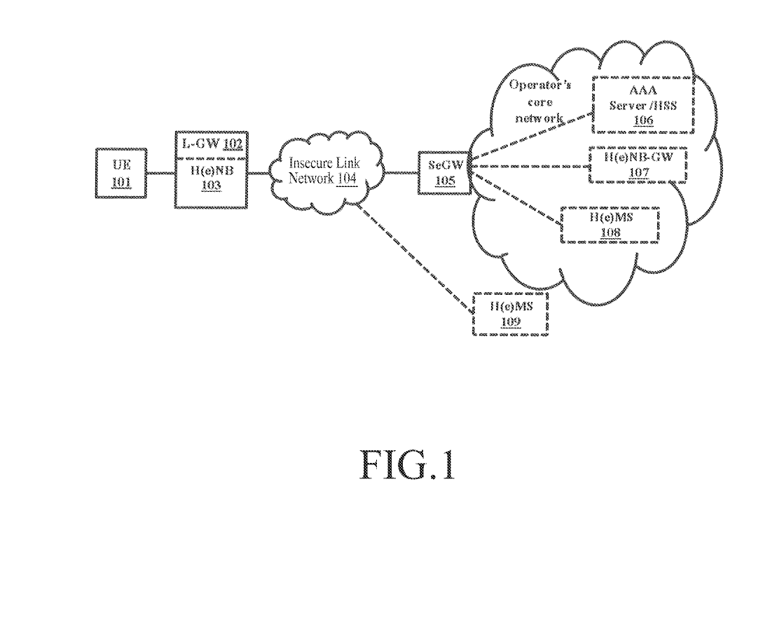

Referring now to the drawings, and more particularly to FIGS. 1 through 7, where similar reference characters denote corresponding features consistently throughout the figures, there are shown preferred embodiments.

FIG. 1 illustrates the H(e)NB (Home (evolved) NodeB) security architecture interconnecting with the Security Gateway (SeGW) in IKEv2 procedure, according to embodiments as disclosed herein. The User equipment (UE) 101 is in communication with the H(e)NB 103 which has co-located local gateway (L-GW) 102. The H(e)NB 103 may be in communication with the UE 101. In one embodiment, the H(e)NB 103 may be in communication with a plurality of user equipment devices. In one embodiment, the UE 101 may be a mobile device, mobile phone, tablet, Personal Digital Assistant (PDA) and the like. In another embodiment, the user equipment is a mobile terminal supported by UMTS and/or LTE service.

The standardized security architecture from Femto Forum as well as from many mobile standards (e.g. 3G, LTE and WiMAX) are good examples that all have common architecture to leverage the IKEv2 to interconnect the Femtocell AP (FAP) with the Security Gateway (SeGW) 105 over the insure link network 104 (e.g. ADSL, Cable networks and soon). A Security Gateway 105 provides secure termination and aggregation for users and signaling traffic to reach the mobile operator's core network.

Further the security gateway 105 is connected with the operator's core network that comprises of an AAA server 106 or a HSS. An AAA server 106 is a server program that handles user requests for access to network resources and, for an enterprise, provides authentication, authorization, and accounting (AAA) services. The AAA server 106 typically interacts with network access and gateway servers and with databases and directories containing user information. A HSS (Home Subscriber Server) or User Profile Server Function (UPSF) is a master user database that contains the subscription-related information (subscriber profiles), performs authentication and authorization of the user, and provides information about the subscriber's location and IP information.

The operator's core network comprise of H(e)NB-GW (Gateway) 107 which is the concentrate point of H(e)NB and it controls the H(e)NB registration. In one embodiment, H(e)NB-GW 107 handles UMTS specific signaling. In another embodiment, H(e)NB-GW 107 handles LTE specific signaling. Further the operator's core network comprise of H(e)MS (H(e)NB management system) 108 which is used to send configuration parameters to the H(e)NB 103 and to manage the H(e)NB 103 by the mobile operator. Another H(e)MS 108 is connected with the H(e)NB through insure link 104 directly.

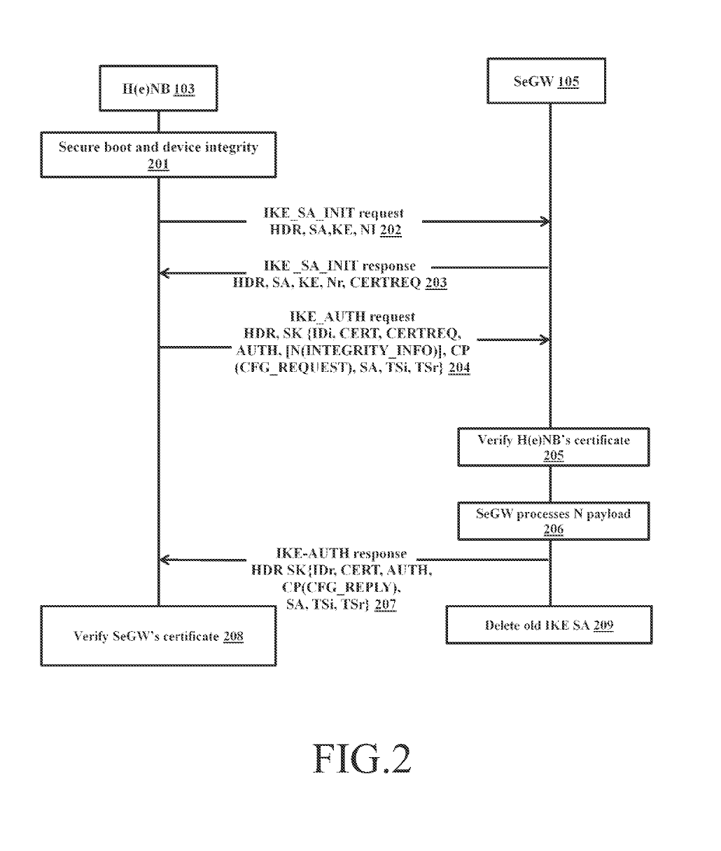

FIG. 2 illustrates the message flow for IKEv2 procedure between the H(e)NB and the core network, according to embodiments as disclosed herein. As depicted in the figure, the H(e)NB 103 authenticates and establish the security association with the Security gateway (SeGW) 105 through the IKEv2 procedure. The procedure starts with a TrE bringing H(e)NB 103 to secure boot and performs (201) device integrity check of H(e)NB 103. Trusted execution environment or the trusted environment (TrE) may be an important component of the Femtocell architecture, as it provides the ‘device internal’ security upon which the other external security features depend on. For example, the authentication between the Femtocell and the carrier network is done using credentials that are stored within the secure storage in the TrE.

After successful device integrity check, the H(e)NB 103 sends (202) an IKE_SA_INIT request to the SeGW 105. The purpose of this request is to negotiate a mutually agreeable set of cryptographic parameters. Then, SeGW sends (203) IKE_SA_INIT response, requesting a certificate from the H(e)NB 103. Further, the H(e)NB 103 sends (204) its identity in the IDi payload in this first message of the IKE_AUTH phase, and begins negotiation of child security associations. In this exchange the peers authenticate the previous messages, present to each other their identities and in some cases certificates. These messages are partially encrypted and integrity protected to hide identities of the peers from possible eavesdroppers. In one embodiment, optionally a user profile also be selected based on the H(e)NB's identity presented in the IDi payload and the authentication type indication in the user profile also be used to enforce the choice of authentication (device only or combined device and Hosting Party authentication). The H(e)NB 103 sends the AUTH payload and its own certificate, and also requests a certificate from the SeGW 105. Configuration payload with one or two attribute request is carried in this message, if the H(e)NB's and/or L-GW's remote IP addresses should be configured dynamically. In one embodiment, H(e)NB 103 includes Notify Payload containing information of device id or device name, to differentiate the IP address request for different entities or services, with a Notification Type of CFG_INFO. H(e)NB 103 optionally includes a Notify Payload containing integrity information of H(e)NB 103 with a Notification Type of INTEGRITY_INFO in the IKE_AUTH request. Computation of the AUTH parameter is performed within the H(e)NB's TrE. If configured to check the validity of the SeGW 105 certificate the H(e)NB 103 retrieves SeGW certificate status information from the OCSP responder. OCSP (Online Certificate Status Protocol) is one of two common schemes for maintaining the security of a server and other network resources. The other, older method, which OCSP has superseded in some scenarios, is known as Certificate Revocation List (CRL). OCSP overcomes the chief limitation of CRL, the fact that updates must be frequently downloaded to keep the list current at the client end. When a user attempts to access a server, OCSP sends a request for certificate status information. The server sends back a response of “current”, “expired,” or “unknown.” The protocol specifies the syntax for communication between the server (which contains the certificate status) and the client application (which is informed of that status). OCSP allows users with expired certificates a grace period, so they can access servers for a limited time before renewing.

After that, SeGW checks the correctness of the AUTH received from the H(e)NB 103 and calculates the AUTH parameter which authenticates the second IKE_SA_INIT message. The SeGW 105 verifies (205) the certificate received from the H(e)NB 103. In one embodiment, the SeGW 105 may check the validity of the certificates using CRL or OCSP. If the H(e)NB 103 request contained an OCSP request, or if the SeGW 105 is configured to provide its certification revocation status to the H(e)NB 103, the SeGW 105 retrieves SeGW certificate status information from the OCSP server, or uses a valid cached response if one is available. Then the SeGW 105 processes (206) the N payload of the IKE_AUTH request based on local policy of the operator. In one embodiment, SeGW 105 may choose to retain the information carried in the N payload for statistical analysis, send the information to FIGS (Fraud Information Gathering System) for fraud detection, or send the information to a validation entity for validation.

After that the SeGW 105 sends (207) its identity in the IDr payload, the AUTH parameter and its certificate to the H(e)NB 103 together with the configuration payload, security associations, and the rest of the IKEv2 parameters and the IKEv2 negotiation terminates. The Remote IP addresses are assigned in the configuration payload (CFG_REPLY), if the H(e)NB 103 requested for H(e)NB's and/or L-GW's Remote IP addresses through the CFG_REQUEST.

In one embodiment, SeGW 105 includes Notify Payload containing information of device id or device name and corresponding IP address assignment to it, to differentiate the assignment, with a Notification Type of CFG INFO.

Further, the H(e)NB 103 verifies (208) the SeGW certificate with its stored root certificate. The root certificate for the SeGW certificate is stored in the TrE. The H(e)NB 103 checks that the SeGW 105 identity as contained in the SeGW certificate equals the SeGW identity as provided to H(e)NB 103 by initial configuration or by H(e)MS 108. The H(e)NB 103 checks the validity of the SeGW 105 certificates using the OCSP response, if configured to do so.

Further, if the SeGW 105 detects that an old IKE SA for that H(e)NB 103 already exists, it deletes (209) the old IKE SA and send the H(e)NB 103 an INFORMATIONAL exchange with a Delete payload in order to delete the old IKE SA in H(e)NB 103.

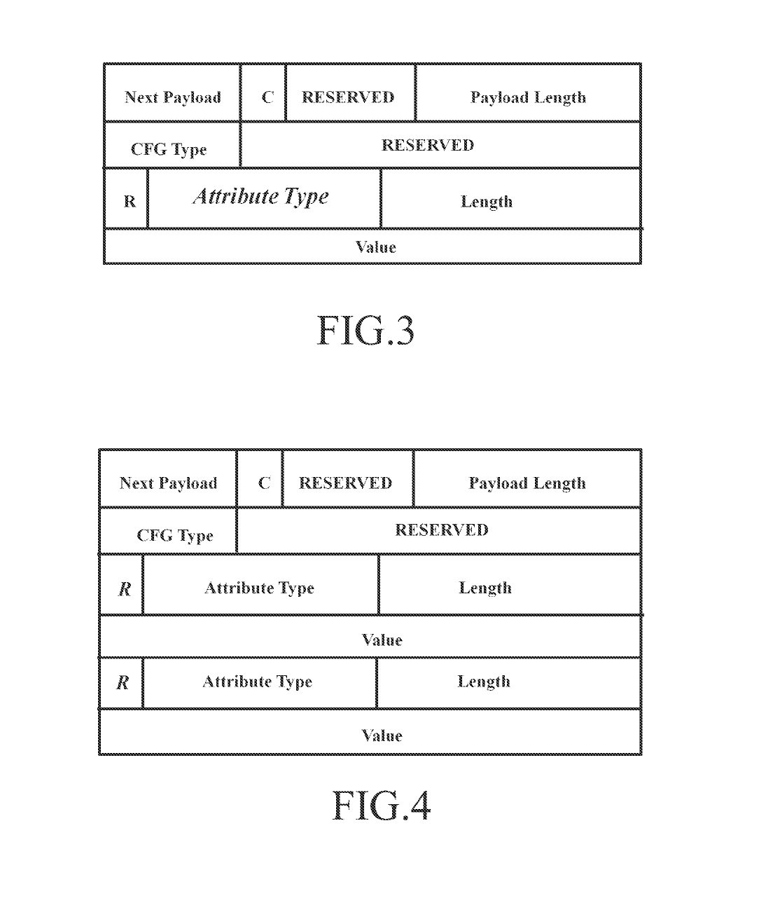

FIG. 3 illustrates the H(e)NB notification using Configuration Payload Attribute Type employing Internet Key Exchange Version 2 protocol (IKEv2) procedure, according to embodiments as disclosed herein. As depicted in the figure for multiple IP request from different entities (logical or physical), the H(e)NB (IKEv2 peer) enclose an unique identifier in the Attribute Type Value for which network entity assign an IP address. In one embodiment the combined H(e)NB/L-GW node uses two different addresses: one for the H(e)NB function and the other one for the L-GW function. For example, an IPsec tunnel between H(e)NB 103 and SeGW 105 is established, in accordance with 3GPP systems with the IKEv2 protocol. Accordingly, the IKEv2 protocol allows the “initiator” to request multiple “internal IP addresses” via the CFG_REQUEST configuration payload during the initial IKEv2 exchange. In the “initiator” role, the combined HeNB/L-GW node may then request at least two internal IP addresses and assign one to the H(e)NB and another one to the L-GW 102 functions.

Attribute Type in CFG_Request and CFG Response in general are:

<XXX>_IP4_<YYY> or

<XXX>_IP6_<YYY> or

<XXX>_<YYY>_IP4 or

<XXX>_<YYY>_IP6

Where, XXX can be INTERNAL or EXTERNAL and YYY represents entity or service or interface or application indication/name.

CFG Type is the type of exchange represented by the Configuration Attributes. The CFG type may be CFG_REQUEST, CFG_REPLY, CFG_SET and CFG_ACK.

Attribute Type is a unique identifier for each of the Configuration Attribute Types. Every attribute type has a value and length. For example, the attribute types can be represented as below:

INTERNAL_IP4_HNB

INTERNAL_IP4_LGW

INTERNAL_IP4_HeNB

INTERNAL_IP4_H(e)NB

INTERNAL_IP4_IMS

EXTERNAL_IP4_H(e)NB_NAT

In one embodiment, the attribute type may be represented as INTERNAL_IP4_ADDRESS with the value of 1 and having the length of 0 or 4 octets. Multiple internal addresses may be requested by requesting multiple internal addresses attributes. The responder may only send up to the number of addresses requested.

In one embodiment, the Identifier is known to the IKEv2 peers as a standardize value. In one embodiment, the identifier is pre-configured as Vendor specific values. These values are also used in CFG_SET/CFG_ACK payloads. Vendor ID payload also be included, if the values/entities belong to a specific scenario/network. The next payload field indicates the type of payload that immediately follows the header. It is the identifier for the payload type of the next payload in the message. If the current payload is the last in the message, then this field will be 0. This field provides a “chaining” capability whereby additional payloads can be added to a message by appending it to the end of the message and setting the “Next Payload” field of the preceding payload to indicate the new payload's type.

FIG. 4 illustrates the Gateway notification using Configuration Payload Reserved bit, according to embodiments as disclosed herein. In one embodiment, for multiple IP request from different entities (logical or physical), the H(e)NB (IKEv2 peer) enclose a unique identifier in Reserved bit of configuration attribute payload for which the network entity will assign an IP address. These solutions have limitation of assigning two IP addresses only.

In one embodiment, Configuration Payload Reserved bit “0” indicates H(e)NB IP address and “1” indicates L-GW IP address. The Identifier is known to the IKEv2 peers as a standardize value. In one embodiment, the identifier is pre-configured as Vendor specific values. The values are also used in CFG_SET/CFG_ACK payloads. Vendor ID payload also be included, if the values/entities belong to a specific scenario/network.

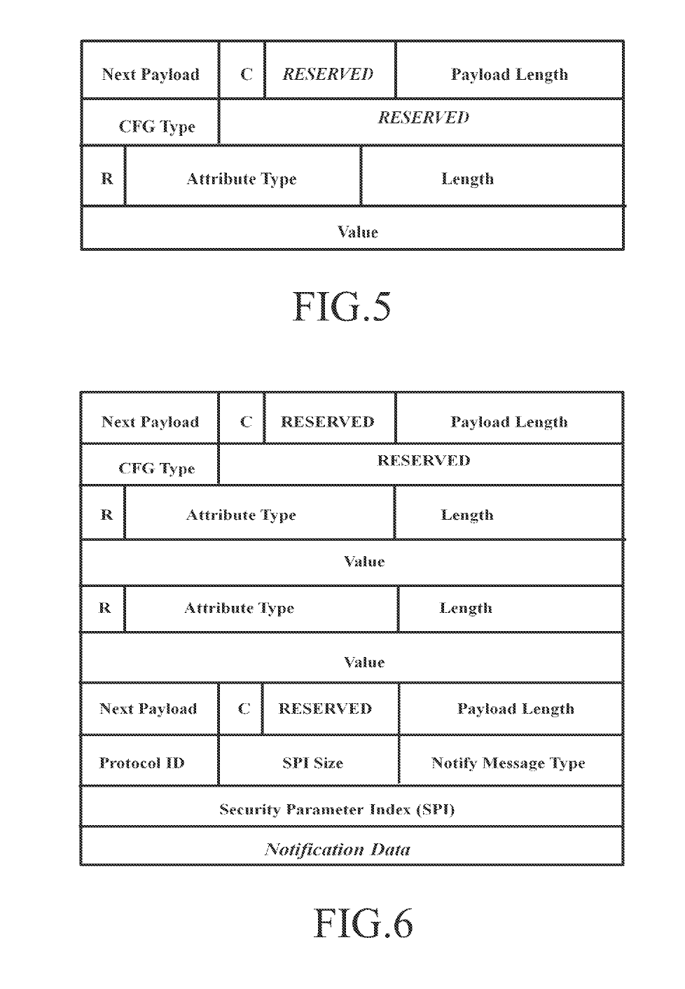

FIG. 5 illustrates the initiator or responder using the reserved bytes in the Generic Payload Header when used by Configuration Payload to indicate the device/service requesting the IP address, according to embodiments as disclosed herein. In one embodiment, Initiator or responder uses the RESERVED bits in the Generic Payload Header to indicate the device/service requesting the IP address. The indicator can be value or string. Vendor ID payload may be included if the values/entities belong to a specific scenario/network. In one embodiment, the service may be an IP Multimedia Subsystem (IMS) that delivers Internet Protocol (IP) multimedia services.

FIG. 6 illustrates a notification using Notified Payload along with the CFG_REQUEST and CFG_REPLY payload in the messages the identities or names or values are exchanged, according to the embodiments as disclosed herein. In one embodiment, using Notified Payload along with the CFG_REQUEST and CFG_REPLY payload, in the messages the identities or names or values are exchanged. Now the SeGW knows which address to be assigned to which device or service or functional entity and the H(e)NB knows which address to be configured to which device or service or functional entity. In one embodiment, Vendor ID payload also be included, if the values/entities belong to a specific scenario/network.

Information regarding the differentiation of the IP addresses is carried in the Notify Payload during IKEv2 procedures from the SeGW 105 to the H(e)NB 103. H(e)NB 103 includes a Notify Payload containing differentiation information with any of the Notification Message Type as shown below.

CFG_INFO

INTERNAL_ADDRESS_INFO

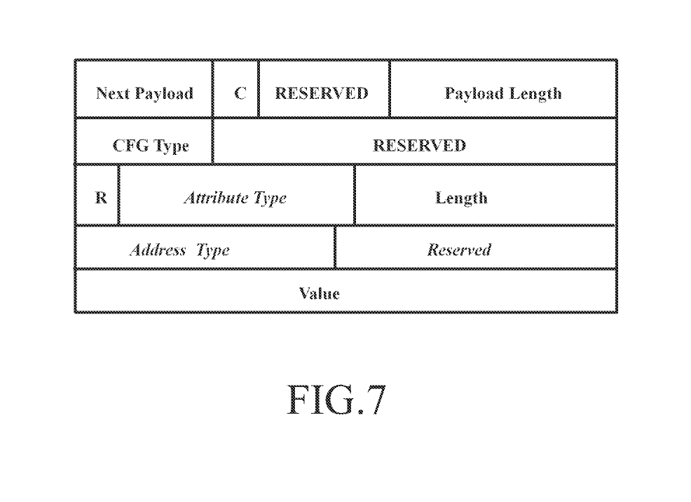

FIG. 7 illustrates the H(e)NB notification using CFG Attribute Type using Internet Key Exchange Version 2 protocol (IKEv2) procedure, according to embodiments as disclosed herein. In one embodiment, for multiple IP request from different entities (logical or physical) and/or services, the H(e)NB (IKEv2 peer) encloses an unique identifier in the Attribute Type Value for which network entity may assign an IP address.

New attribute types are:

INTERNAL_TYPED IPV4_ADDRESS

INTERNAL_TYPED_IPV6_ADDRESS

EXTERNAL_TYPED_IPV4_ADDRESS

EXTERNAL_TYPED_IPV6_ADDRESS

Value field starts with 16-bit Address_Type, followed by 16-bit Reserved Field, and 32/128 bit for IPv4/IPv6 address. In one embodiment, Reserved field is for alignment, Field sizes and presence of Reserved Field may be subject to change.

In one embodiment, INTERNAL_IP4_ADDRESS has a value 1 and having a length of 0 or 4 octets and INTERNAL_IP6_ADDRESS has a value 8 and having a length of 0 or 16 octets.

Following Address_Types are defined in general as:

<XXX>_IP4_<XXX> or

<XXX>_IP6_<XXX> or

<XXX>_IP6_<YYY> or

<XXX>_<YYY>_IP4 or

<XXX>_<YYY>_IP6

Where, XXX can be INTERNAL or EXTERNAL and YYY represents entity or service or interface or application indication/name.

For example the Attribute type may as follows:

INTERNAL_IP4_HNB

INTERNAL_IP4_LGW

INTERNAL_IP4_HeNB

INTERNAL_IP4_H(e)NB

INTERNAL_IP4_IMS

EXTERNAL_IP4_H(e)NB_NAT

In one embodiment, the Identifier will be known to the IKEv2 peers as a standardized value. In one embodiment, the identifier is pre-configured as Vendor specific values. The values are also used in CFG_SET/CFG_ACK payloads. Vendor ID payload may be included if the values/entities belong to a specific scenario/network.

The embodiments disclosed herein can be implemented through at least one software program running on at least one hardware device and performing network management functions to control the elements. The elements shown in FIGS. 1 and 2 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for assigning Internet Protocol (IP) addresses for at least one service in an Internet Key Exchange version 2 (IKEv2) procedure in a communication network that includes at least one Home Gateway and at least one network security gateway, the method comprising:
sending a request in a configuration payload, by the Home Gateway, to the security gateway for allocation of service specific IP addresses for each of the at least one service;
processing of the request in the configuration payload by the security gateway; and
sending, by the security gateway, a response to the Home Gateway in the configuration payload indicating the IP addresses for the at least one service.

2. The method of claim 1, wherein the sending of the request in the configuration payload comprises employing at least one attribute request in the configuration payload request for at least one of information and dynamic allocation of IP addresses for at least one of the Home Gateway and a local gateway.

3. The method of claim 1, wherein the sending of the request in the configuration payload is done by employing a unique identifier in an attribute type value in the payload for which the security gateway provides an IP address.

4. The method of claim 3, wherein the identifier is at least one of being known to the IKEv2 peers as a standardized value and being pre-configured as network operator specific values.

5. The method of claim 1, wherein the sending of the request in the configuration payload is done employing a unique identifier in a reserved bit of a configuration attribute payload for which the security gateway provides an IP address.

6. The method of claim 5, wherein a zero in the reserved bit indicates the IP address is for the Home Gateway and a one in the reserved bit indicates the IP address is for the local gateway.

7. The method of claim 1, wherein generic payload header reserved bits are employed in at least one of a configuration payload request and a configuration payload response to differentiate IP addresses for the at least one service.

8. The method of claim 1, wherein notification data of a notify payload is employed in at least one of a configuration payload request and a configuration payload response to differentiate IP addresses for the at least one service.

9. The method of claim 1, wherein the method employs at least one of a device identity, a device name, a service identity, a service name, an interface name, an application identity, and an application name in the configuration payload as differentiators for indication of the IP address request and assignment.

10. The method of claim 1, wherein the configuration payload is provided by a network operator and is specific to the network operator.

11. The method of claim 1, wherein the processing of the request in the configuration payload comprises verification of the Home Gateway and processing of the notification payload of the IKEv2 request according to a local policy of a network operator.

12-13. (canceled)

14. A system for assigning Internet Protocol (IP) addresses for services in an Internet Key Exchange version 2 (IKEv2) procedure in a communication network that includes IKEv2 peers, wherein the system performs the method of claim 1.

15. A Home Gateway for differentiation of Internet Protocol (IP) addresses for services in an Internet Key Exchange version 2 (IKEv2) procedure in a communication network, the Home Gateway comprising:
a transmitter configured to send a request in an IKEv2 configuration payload to a security gateway for allocation of specific IP addresses for each of the service served by the Home Gateway; and
a receiver configured to receive a response in the IKEv2 configuration payload indicating assignment of the IP addresses for the services front the security gateway.

16. The Home Gateway of claim 15, wherein the transmitter is configured to send the request in the IKEv2 configuration payload employing a unique identifier in an attribute type value in the IKEv2 configuration payload for which the security gateway entity provides an IP address.

17. The Home Gateway of claim 15, wherein the transmitter is configured to send the request in the IKEv2 configuration payload employing an unique identifier in a reserved bit of a IKEv2 configuration attribute payload for which the security gateway assigns an IP address.

18. The Home Gateway of claim 15, wherein the Home Gateway is configured to employ reserved bits in a IKEv2 configuration payload request to indicate an IP address request for the service.

19. The Home Gateway of claim 15, wherein the Home Gateway is configured to employ notification data in an IKEv2 configuration payload request to indicate an IP address request for the service.

20-21. (canceled)

22. A security gateway for assigning Internet Protocol (IP) addresses for services in an Internet Key Exchange (IKEv2) procedure in a communication network, the security gateway comprising:
a receiver configured to receive a request, in a configuration payload, from a Home Gateway for allocation of specific IP addresses for each the services;
a controller configured to process the request received in the configuration payload by the security gateway; and
a transmitter configured to send a response to the Home Gateway in the configuration payload indicating assignment of the IP addresses for the services.

23. The security gateway of claim 22, wherein the security gateway is configured to employ reserved bits in a configuration payload response to indicate IP address assignments for the services.

24. The security gateway of claim 22, wherein the security gateway is configured to employing notification data in a configuration payload response to indicate IP address assignments for the services.

25. (canceled)
